(19) United States
(12) Patent Application Publication
(10) Pub. No.: US 2013/0297740 A1
(43) Pub. Date: Nov. 7, 2013

(54) METHOD FOR PROVIDING AN OBSERVER WITH DATA RELATED TO AT LEAST ONE USER OF A TELECOMMUNICATION OR INTERNET SERVICES OPERATOR WITHIN A NETWORK

(71) Applicant: Arnaud Ansiaux, Nozay (FR)

(72) Inventor: Arnaud Ansiaux, Nozay (FR)

(21) Appl. No.: 13/995,030

(22) PCT Filed: Jan. 13, 2012
(86) PCT No.: PCT/EP12/50500

§ 371 Date: Jul. 10, 2013

(30) Foreign Application Priority Data
Jan. 13, 2011 (FR) 1100123

(51) Int. Cl. H04L 29/08

(52) U.S. Cl. CPC H04L 67/10
USPC 709/217

(57) ABSTRACT

The invention pertains to a method for providing an observer with data related to at least one user of a telecommunication or Internet services operator within a network, said method providing that said observer send a request to said operator to obtain data in response to said request, said method comprising analyzing the data requested by said observer in response to said request, automatically constructing a new request based on said analysis, and using said new request so that said operator transmits to said observer new data in response to said new request.

The invention pertains to a method for providing an observer with data related to at least one user of a telecommunication or Internet services operator within a network, as well as an architecture for such an operator comprising technical means for implementing such a method.

The world of multimedia communications has completely transformed over the past few years, and the pace seems to be increasing. Consequently, certain risks and threats like cybercrime, corruption, drug trafficking, and terrorism, though not new, are more relevant than ever.

As a result, legal obligations, such as the two functions known as lawful interception (LI) and data retention (DR) appear to be more necessary than ever in order to actively ensure comprehensive security for nations and their citizens. In particular, lawful interception enables an authority to monitor communications between given users within a network in real time, and data retention enables the storage of technical data related to users within such a network so that it may be used afterward by an authority.

In France for example, the number of lawful interceptions nearly quadrupled between 2001 and 2008, according to figures published in the article on the web at the address http://www.lejdd.fr/Societe/Actualite/Tout-le-monde-sur-ecoute-76854. However, these figures are still below the number of lawful interceptions performed in Italy, and especially below the number of lawful interceptions performed in the United States.

Lawful interceptions and data retention are functions that must be provided by operators and Internet service providers (ISPs). In particular, Internet service and telecommunication operators are obligated to store technical data about their customers, e.g. if said customers use a fixed line telephone and/or mobile telephone and/or if said customers have an Internet connection. Legislation may vary from one country to another, particularly with respect to the duration of storage, which may be from six months to three years. For example, French law requires one year of data storage.

From a technical standpoint, these two functions have their own constraints. In particular, the technical constraints of lawful interceptions primarily arise from their real-time nature.

Likewise, the technical constraints of data retention particularly arise from the large quantity of data to be stored; consequently, the time taken to respond to requests may become very long, and constitute an obstacle to operational efficiency. Furthermore, the processing of heterogeneous data from different types of communication networks constitutes a general difficulty.

Currently, each customer of a multimedia communications operator generates around 14 kilobytes (kB) of signal data for voice communication and 100 kB of signal data for data communication, and this trend is constantly moving upward. For this reason, each operator must, given 10 million customers, store about 400 terabytes (TB) of data for one year, which is equivalent to storing 80,000 DVDs and represents 100 billion entries in said operator's database. Furthermore, current multimedia communications operators have far exceeded 10 million customers, particularly France Telecom®, according to the article available at the address http://www.journaledunet.com/ebusiness/breve/france/47671/france-telecom-souhaite-atteindre-300-millions-de-clients.shtml.

Consequently, there is a very large quantity of data to be stored, and it is a great challenge for telecommunication and Internet service operators to ensure the availability, integrity, and privacy of said data.

Furthermore, all of this stored information and data must be useful to authorities in ensuring national security, and to do so must be processed and analyzed.

Additionally, given that the time constraint is one of the most important aspects to be managed during legal investigations and intelligence activities, it is essential to minimize the time taken to respond to those authorities' requests.

In order to correctly manage the decrease in response time to authorities' requests, lawful interception and data retention architectures must be constructed in computing environments (hardware and software) that are sufficiently powerful in terms of both processing capacity and storage capacity. Furthermore, proper internal organization of departments that handle legally mandated functions must also be ensured and constantly maintained.

Without the two aforementioned conditions, no effective coordination is possible between the authorities and the telecommunication and Internet service operators. However, these two conditions are not always sufficient by themselves, in that the volume of data that the authorities must process keeps increasing. Additionally, requests from the authorities are complex and the data to be processed is heterogeneous.

In particular, the authorities increasingly need means that are capable of processing structured and/or non-structured data, for example computer data, video data, image data, or voice data. Additionally, the storage capacities of telecommunication and Internet service operators must not only be large enough, they must also be suitable for different types of multimedia content in order to facilitate the work of correlating and merging the information. This is because telecommunication and Internet service operators are planning to steer their departments towards multimedia, such as videoconferencing and/or indirect conversations using webcams.

As a result, most current databases have reached their limits in the fields of lawful interception and data retention, and more generally in the field of data management. Additionally, new storage technologies are appearing on the market, such as new reference solutions like Greenplum®, Netezza®, Xedix® and Terradata®, which are used by Alcatel-Lucent® in its comprehensive solutions.

Although these new technologies have effective capacities and make it possible to overcome many constraints, it is still possible to significantly increase the overall efficiency of lawful interception and data retention processes, while directly taking into account the authorities' work and skills within the system in order to be able to anticipate recurring actions carried out by said authorities.

Such an aspect requires stronger interaction and closer relationships between the respective architectures of lawful interception and data retention than what is currently observable. This is because standard architectures, particularly those which comply with the ETSI standard (for European Telecommunications Standards Institute), are relatively compartmentalized, and their respective mediation functions act with complete independence, even if, for example, their subjects are processed in the same group within the ETSI.

The invention aims perfect the prior art by proposing a method to significantly improve the speed and efficiency of exchanges between telecommunication operators, Internet service operators, and the authorities, by facilitating the correlating and merging of information obtained by said authorities, particularly through improved interaction between the lawful interception and data retention functions and through anticipating requests from said authorities.

To that end, according to a first aspect, the invention proposes a method for providing an observer with data related to at least one user of a telecommunication or Internet services operator within a network, said method providing that said observer send a request to said operator in order to obtain data in response to said request, said method additionally providing for:
analyzing the data requested by said observer in response to said request;
automatically constructing a new request based on said analysis;
using said new request so that said operator transmits to said observer new data in response to said new request.

According to a second aspect, the invention proposes an architecture for a telecommunication or Internet services operator within a network, said architecture comprising at least one database in which is stored data related to at least one user of said operator, said architecture comprising means for receiving a request sent by an observer to said operator in order to obtain data in response to said request, said architecture further comprising:
at least one module for analyzing the data requested by the observer in response to said request;
at least one module for automatically constructing a new request based on the analysis conducted by said analysis module;
at least one module for using said new request so that said operator transmits to said observer new data in response to said new request.
at least one administration module comprising means to cause the analysis, construction, and usage modules to interact with one another in order to transmit to said observer new data in response to said new request.

Other features and advantages of the invention will become apparent in the following description, written in connection with the attached figures, in which:

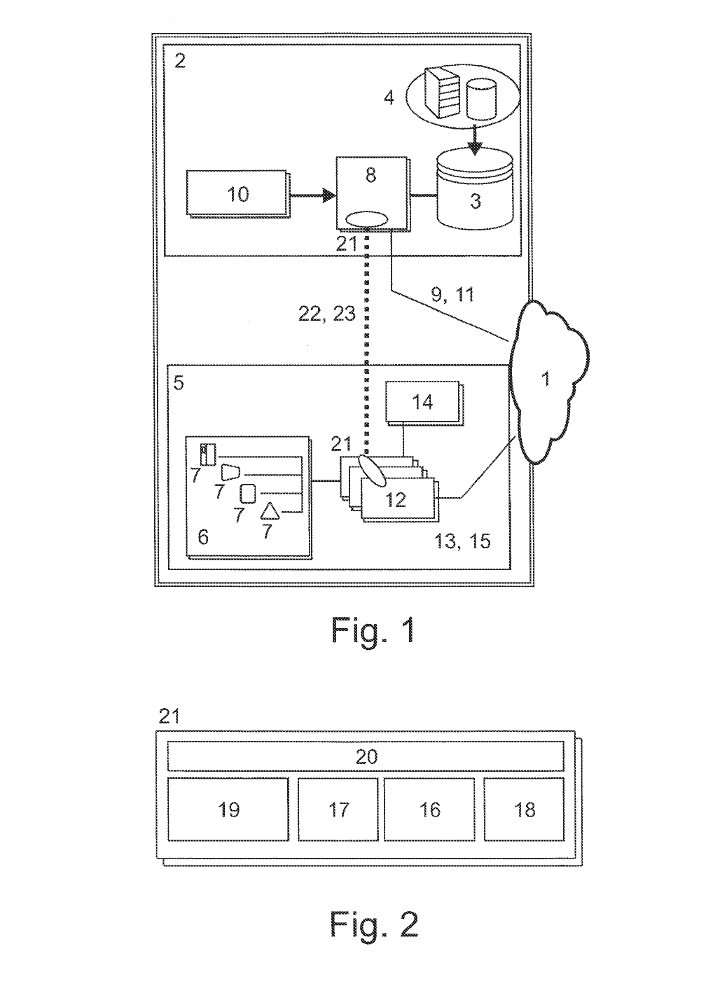

FIG. 1 schematically depicts an architecture of a telecommunications operator integrating two applications capable of implementing a method for providing according to the invention;

FIG. 2 schematically depicts an application of FIG. 1.

In connection with those figures, below is described an architecture of a telecommunications operator within a network 1. The operator may be, in particular, a fixed-line, mobile, voice, and/or data communications operator, for example a telecommunications operator such as Orange® or Bouygues Télécom®, or an Internet telephony operator (VoIP, for Voice over Internet Protocol) and/or a videoconferencing operator and/or an Internet service provider.

The architecture comprises means for implementing a method for providing an observer with data related to at least one user of the operator within the network 1. The observer, not depicted in the figures, is a legal authority (LEA, for Law Enforcement Agency), such as the National Police or National Gendarmerie, or a ministry, such as the Ministry of Defense or Ministry of Justice.

The architecture comprises at least one database in which is stored data related to at least one user of the operator.

In connection with FIG. 1, the architecture integrates a data retention sub-architecture 2 comprising at least one base 3 in which is stored technical data related to users who are the operator's customers, for example data related to the identifiers of the operator's users, the type of multimedia communications initiated by the users, the log of said communications, or the identifiers of the contacts of said users participating in said communications.

In particular, the identifiers of the users and/or of their contacts may be telephone numbers, IP (for Internet Protocol) addresses, blog addresses, or addresses of real-time discussion (or chat) sites. Furthermore, for the operator's users, the identifiers may also be the names of said users.

This data is sent to the database 3 by an information system 4 (IS) of the operator, in order to be gathered and stored within said database.

Furthermore, the architecture incorporates a lawful interception sub-architecture 5 comprising at least one platform 6 for the telecommunication operator, said platform comprising at least one interface 7 for a network of the operator, for example a fixed-line telephony network, a mobile telephony network, or an Internet-providing network, said interface granting access to data related to said real-time communications between users within the network 1, at least one of said users being a user of the operator in question.

In particular, the data accessible by means of an interface 7 may relate to the identifiers of the operator's users and/or the identifiers of said users' contacts for participating in a real-time communication with said users, or the type and/or content of said real-time communications.

Furthermore, preferentially, the data stored within the database 3 and the data accessible by means of an interface 7 comprise at least one telephone number of a user and/or at least one telephone number of a contact of said user within the network 1, with the observer sending a request to obtain at least one of said numbers as a piece of data, in order to set up a lawful interception process based on said number and/or to obtain technical data about said number.

The method provides that the observer send a request to the operator in order to obtain data in response to said request. The architecture therefore comprises means for receiving a request sent via the network 1 by the observer to the operator in order to obtain data in response to send request or to implement an interception in real-time.

In FIG. 1, the data retention sub-architecture 2 comprises at least one mediation module 8 that comprises means for receiving a request 9 sent by the observer in order to obtain data stored within the database 3, said data relating to a user of the operator.

The module 8 may, in particular, be a high-definition multimedia interface (HDMI) module, and the request 9 may be sent by the observer to said module by means of an administrative handover interface HIA.

Furthermore, the sub-architecture 2 comprises an interface module 10 capable of causing the module 8 to interact with the database 3, in order to extract from said database the requested data and to transmit to the observer a notification 11 in response to the request 9, said notification comprising said data.

To do so, the module 10 may send instructions to the module 8 by means of an administrative handover interface HIA, in which case the notification 11 may be transmitted to the observer by means of a data handover interface HIB.

Likewise, the lawful interception sub-architecture 5 comprises at least one mediation module 12 that comprises means for receiving a request 13 sent by an observer in order to obtain data by means of an interface 7, said data relating to a user of the operator.

In particular, the observer may send a request 13 to the module 12 by means of a handover interface HI1 for managing the lawful interception functions.

Furthermore, the sub-architecture 5 comprises an interface module 14 capable of causing the module 12 to interact with the platform 6, in order to obtain the requested data by means of at least one interface 7 and to transmit to the observer a notification 15 in response to the request 13, said notification comprising said data. In particular, the data accessible by means of an interface 7 is transmitted in real time to an observer in notifications 15 without said data actually being stored within the lawful interception sub-architecture 5.

The module 14 may send instructions to the module 12 by means of a handover interface HI1 for managing lawful interception functions, in which case the notification 15 may be transmitted to the observer by means of a handover interface HI2 if it comprises technical data related to a real-time communication of the user within the network 1, or by means of a handover interface HI3 if it comprises data related to the contents of such a communication.

The method provides for analyzing the data requested by the observer in response to the request 9, 13, particularly before said observer obtains said data. To do so, the architecture comprises at least one module 16 for analyzing the data requested by the observer in response to the request 9, 13.

In particular, the requested data may be analyzed by means of filtering rules. These filtering rules may particularly be generated based on an analysis of a log of previous requests 9, 13 sent by the observer and data obtained in response to said previous requests. These filtering rules may also be constructed by an administrator of the architecture, with recommendations from the observer.

To do so, the architecture comprises at least one module 17 for generating filtering rules, comprising means for analyzing a log of previous requests 9, 13 sent by the observer and data obtained in response to said previous requests, as well as means for generating filtering rules based on said analysis. Furthermore, the module 16 is capable of analyzing the data requested by the observer by means of filtering rules generated by the module 17.

In particular, the filtering rules depend on the nature of the observer's activity and its work methods, and may particularly pertain to the requests that the observer habitually sends the operator after having received a certain type of data.

For example, if the observer, after having received a piece of data comprising a telephone number of a user and/or a telephone number of a contact of said user, habitually sends a request 9 to the sub-architecture 2 in order to obtain the telephone number of the user's seven contacts who have most frequently called said user or have been most frequently contacted by said user, the means for analyzing the module 17 may be capable of identifying that habit, and said module's means for generation may be capable of generating a filtering rule pertaining to said identified habit.

Once the data requested by the observer has been analyzed by the module 16, the method provides for automatically constructing a new request based on said analysis. To do so, the architecture comprises at least one module 18 for automatically constructing a new request based on the analysis conducted and transmitted by the module 16. The new constructed request corresponds in particular to the request that the observer would have made after obtaining and analyzing the data that it had requested, and therefore anticipates said observer's behavior.

The method provides for using the new constructed request so that the operator transmits to the observer new data in response to said new request. To do so, the architecture comprises at least one module 19 for using the news and at least one administration module 20 comprising means to cause the analysis 16, construction 18 and usage 19 modules to interact with one another in order to transmit to the observer new data in response to said new request.

In particular, the administration module 20 may comprise means to enable the observer to manually generate filtering rules and means for sending said generated rules to the generation module 17.

Preferentially, the new data obtained in response to the new constructed requests are stored locally, for example in a database (not depicted) of the corresponding sub-architecture 2-5, before being transmitted to the observer, in order to avoid any loss of data between the operator and the observer.

The usage module 19 may comprise means for making the usage of the new request secure, particularly by ensuring the integrity and privacy of said usage by means of an encryption code and/or privacy certificates.

In connection with FIG. 2, the analysis 16, rules-generating 17, construction 18, usage 19, and administration 20 modules are gathered in an application 21, said application being installed within the architecture of a telecommunication or Internet services operator to implement the method, particularly in at least one of the sub-architectures 2, 5.

In particular, the data retention 2 and lawful interception 5 sub-architectures respectively comprise an application 21, each of said applications comprising the modules described above, particularly a module 19 for using the new requests.

The results of the new constructed requests may be indexed in a database. In particular, the module 18 of the sub-architecture 2 may comprise means for indexing within a data retention database the new requests it has constructed, for example by creating logical links for said new requests, the module 19 being capable of causing the mediation module 8 to interact with that database by using said logical links so that the module 8 extracts from the database 3 new data in response to said new requests.

Furthermore, the module 18 of the sub-architecture 5 may comprise means for preparing, based on new constructed requests, routing tables, a virtual private network (VPN) configuration, or other techniques, so that the mediation module 12 interacts with at least one interface 7 of the platform 6 in order to obtain new data in response to said new requests.

The method may provide that, if the request sent by the observer is a data retention request 9—or respectively, a lawful interception request 13—, the new constructed request is also a data retention request—or respectively, a lawful interception request.

Thus, the sub-architecture 2, 5 receiving the request 9, 13 sent by the observer is also the recipient of the new constructed request, the module 19 of the application 21 installed within said sub-architecture locally transmits said new request to the mediation module 8, 12 of said sub-architecture.

For example, if the observer had previously sent a request 9 to the sub-architecture 2 to obtain the name of a user and if said observer habitually then sends a request to obtain the log of said user's communications, the module 16 of the application 21 installed within said sub-architecture may, in collaboration with the module 17 of said application, apply the filtering rules corresponding to that habit so that the module 18 constructs a new request and the module 19 locally transmits said new request to the module 8.

Likewise, if the observer had previously sent a request 13 to the sub-architecture 5 to monitor a real-time communication of a user within the network 1, and if said observer habitually then sends a request to obtain the telephone number of said user's contact who is participating in said communication, the module 16 of the application 21 installed within said sub-architecture may, in collaboration with the module 17 of said application, apply the filtering rules corresponding to that habit so that the module 18 constructs a new request and the module 19 locally transmits said new request to the module 12.

The method may also provide that, if the request sent by the observer is a data retention request 9—or respectively, a lawful interception request 13—, the new constructed request is a lawful interception request—or respectively, a data retention request.

Thus, the sub-architecture 2, 5 receiving the request 9, 13 sent by the observer is not the recipient of the new constructed request, the module 19 of the application 21 installed within said sub-architecture securely transmits said new request to the mediation module 8, 12 of the other sub-architecture 2,5.

For example, if the observer had previously sent a request 9 to the sub-architecture 2 to obtain the telephone numbers of the seven contacts who have most frequently called a user of the operator, and if said observer then habitually requests a lawful interception for those seven contacts, the module 16 of the application 21 installed within said sub-architecture may, in collaboration with the module 17 of said application, apply the filtering rules corresponding to that habit so that the module 18 automatically constructs a new lawful interception request 22.

The new request 22 is then transmitted by the module 19 of the application 21 installed in the data retention sub-architecture 2 to the mediation module 12 of the lawful interception architecture 5, so that the module 12 interacts with the platform 6 to implement the lawful interception for the seven contacts.

Likewise, if the observer had previously send a request 13 to the sub-architecture 5 to monitor the real-time communications of a user of the operator within the network 1 and if said observer then habitually requests the telephone number of the contact with which said user has a real-time communication, the module 16 of the application 21 installed within said sub-architecture may, in collaboration with the module 17 of said application, apply the filtering rules corresponding to that habit so that the module 18 constructs a new data retention request 23.

The new request 23 is then transmitted by the module 19 of the application 21 installed in the law interception sub-architecture 5 to the mediation module 8 of the data retention architecture 2, so that the module 8 extracts from the database 3 the telephone number of said contact.

Thus, an interaction between the data retention 2 and lawful interception 5 sub-architectures is established, and makes it possible to significantly improve the effectiveness and speed of those two sub-architectures 2, 5 by automatically constructing new requests that anticipate the requests of the observer, making said sub-architectures reliable investigative and decision support tools for the authorities.

1. A method for providing an observer with data related to at least one user of a telecommunication or Internet services operator within a network, said method providing that said observer send a request to said operator to obtain data in response to said request, said method comprising:
analyzing the data requested by said observer in response to said request;
automatically constructing a new request based on said analysis; and
using said new request so that said operator transmits to said observer new data in response to said new request.

2. The method according to claim 1, further comprising analyzing the requested data by means of filtering rules.

3. The method according to claim 2, further comprising generating the filtering rules based on an analysis of a log of previous requests sent by the observer and on data obtained in response to said previous requests.

4. The method according to claim 1, wherein the data requested by the observer comprises at least one telephone number of the user and/or at least one telephone number of a contact of said user within the network.

5. The method according to claim 4, wherein the new constructed requests are indexed in a database.

6. The method according to claim 5, wherein the new data obtained in response to the new constructed requests are stored locally before being transmitted to the observer.

7. The method according to claim 6, wherein the request sent by the observer is a data retention request or a lawful interception request, the new constructed request being a lawful interception request.

8. The method according to claim 6, wherein the request sent by the observer is a data retention request or a lawful interception request, the new constructed request being a data retention request.

9. An architecture for a telecommunication or Internet services operator within a network, said architecture comprising at least one database in which is stored data related to at least one user of said operator, said architecture comprising means for receiving a request sent by an observer to said operator to obtain data in response to said request, said architecture further comprising:
at least one analysis module for analyzing the data requested by the observer in response to said request;
at least one construction module for automatically constructing a new request based on the analysis conducted by said at least one analysis module;
at least one usage module for using said new request so that said operator transmits to said observer new data in response to said new request; and
at least one administration module comprising means to cause the at least one analysis module, the at least one construction module, and the at least one usage module to interact with one another to transmit to said observer new data in response to said new request.

10. The architecture according to claim 9, further comprising at least one module for generating filtering rules, the at least one analysis module being capable of analyzing the data by means of said filtering rules, said generation module comprising means for analyzing a log of previous requests sent by the observer and data obtained in response to said previous requests, as well as means for generating filtering rules based on said analysis.

11. The architecture according to claim 9, wherein the at least one administration module comprises means to enable an observer to manually generate filtering rules and means for sending said generated rules to the generation module.

12. The architecture according to claim 9, wherein the at least one usage module comprises means to secure the use of the new request.

13. The architecture according to claim 9, further comprising a data retention sub-architecture and a lawful interception sub-architecture, said sub-architectures comprising at least one database configured to store data related to at least one user of said operator and/or a module comprising means for receiving a request sent by an observer, each of said sub-architectures further comprising an application comprising an analysis module, a construction module, a usage module, and an administration module.
